(19) United States
(12) Patent Application Publication
(10) Pub. No.: US 2007/0132808 A1
(43) Pub. Date: Jun. 14, 2007

(54) INK JET PRINTING APPARATUS AND PROTECTING STRUCTURE OF PRINTING CARTRIDGE THEREOF

(75) Inventor: Zhong-Ming Wang, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/549,135

(22) Filed: Oct. 13, 2006

(30) Foreign Application Priority Data
Oct. 25, 2005 (TW) 94137345

(51) Int. Cl. B41J 2/165

(52) U.S. Cl. 347/29

(57) ABSTRACT

An inkjet printing apparatus includes a cartridge, a cap, a driving assembly and a transmitting assembly. The cartridge is movable along a first direction. The cap is used for protecting the cartridge. The driving assembly is connected to the cap for providing a force to keep the cap away from the cartridge along a second direction. The transmitting assembly is used for connecting the driving assembly and the cartridge. When the cartridge is at an initial position, the cartridge is against the transmitting assembly to oppose the force. As a result, the cap covers the cartridge. When the cartridge moves along the first direction away from the initial position, the driving assembly provides the force, so that the cap moves away from the cartridge along the second direction.

This application claims the benefit of Taiwan application Serial No 94137345, filed or Oct. 25, 2005, the subject matter of which is incorporated herein by reference.

### BACKGROUND OF THE INVENTION

1. Field of the Invention

The invention relates in general to an inkjet printing apparatus, and more particularly to an inkjet printing apparatus with a protecting structure of a printing cartridge thereof.

2. Description of the Related Art

Nowadays, an inkjet printing apparatus has become an indispensable part of people's lives. For example, the inkjet printing apparatus can be applied to a multifunction device, a fax machine or a printer for home or office. Moreover, the inkjet printing apparatus can even be applied to consumer electronic products, such as an automated teller machine, a cash register and a credit card reader.

A cartridge of the inkjet printing apparatus is movable along a longitudinal direction. A nozzle surface is on the bottom of the cartridge for jetting out ink on printing paper in order to print out data.

However, after the conventional inkjet printer finishes printing, the nozzle surface is exposed to the air. Ink remaining on the nozzle surface dries out and then clogs the nozzle surface. As a result, the printer can not print smoothly. Additionally, particles in the air adhere to the nozzle surface, and the printing quality of the conventional inkjet printer is affected seriously.

### SUMMARY OF THE INVENTION

It is therefore an object of the invention to provide an inkjet printing apparatus and a protecting structure of a cartridge thereof. When the cartridge returns to an initial position, the protecting structure covers a nozzle surface of the cartridge through a transmitting assembly and a driving assembly in order to protect the cartridge.

The invention achieves the above-identified object by providing an inkjet printing apparatus including a cartridge, a cap, a driving assembly and a transmitting assembly. The cartridge is movable along a first direction. The cap is used for protecting the cartridge. The driving assembly is connected to the cap for provide a force to keep the cap away from the cartridge along a second direction. The transmitting assembly is used for connecting the driving assembly and the cartridge. When at an initial position, the cartridge is tightly against the transmitting assembly to provide an external force. The transmitting assembly transmits the external force to the driving assembly to oppose the force. As a result, the cap covers the cartridge. When the cartridge moves away from the initial position along the first direction, the driving assembly provides the force. Accordingly, the cap is keep away from the cartridge along the second direction.

The invention achieves the above-identified object by providing a protecting structure disposed in an inkjet printing apparatus. The inkjet printing apparatus includes at least a housing and a cartridge. The cartridge is movable along a first direction. The protecting structure includes a cap, a driving assembly and a transmitting assembly. The cap is used for protecting the cartridge. The driving assembly is connected to the cap for providing a force to keep the cap away from the cartridge along a second direction. The transmitting assembly is used for connecting the driving assembly and the cartridge. When the cartridge is at the initial position, the cartridge is tightly against the transmitting assembly to provide an external force. The transmitting assembly transmits the external force to the driving assembly to oppose the force. As a result, the cap covers the cartridge. When the cartridge moves away from the initial position along the first direction, the driving assembly provides the force. Accordingly the cap is keep away from the cartridge along the second direction.

Other objects, features, and advantages of the invention will become apparent from the following detailed description of the preferred but non-limiting embodiments. The following description is made with reference to the accompanying structure.

### BRIEF DESCRIPTION OF THE DRAWINGS

FIG. 1A illustrates an inkjet printing apparatus and a protecting structure of a cartridge thereof according to a first embodiment of the invention when the cartridge is at an initial position;

FIG. 1B illustrates a transmitting assembly in FIG. 1A;

FIG. 1C illustrates a driving assembly in FIG. 1A;

FIG. 2 illustrates the inkjet printing apparatus and the protecting structure of the cartridge thereof in FIG. 1A when the cartridge is away from the initial position;

FIG. 3 illustrates the inkjet printing apparatus and the protecting structure of the cartridge thereof in FIG. 1A when the cartridge is away from the transmitting assembly;

FIG. 4 illustrates an inkjet printing apparatus and a protecting structure of a cartridge thereof according to a second embodiment of the invention when the cartridge is at an initial position; and

FIG. 5 illustrates the inkjet printing apparatus and the protecting structure of the cartridge thereof in FIG. 4 when the cartridge is away from the initial position.

### DETAILED DESCRIPTION OF THE INVENTION

The present invention provides an inkjet printing and apparatus and a protecting structure of a cartridge thereof. When the cartridge returns to an initial position, a cap covers a nozzle surface of the cartridge through a transmitting assembly and a driving assembly to protect the cartridge. Please referring to figures, several embodiments are illustrated as follow in order to describe the present invention clearly. However, the present invention is not limited thereto.

### First Embodiment

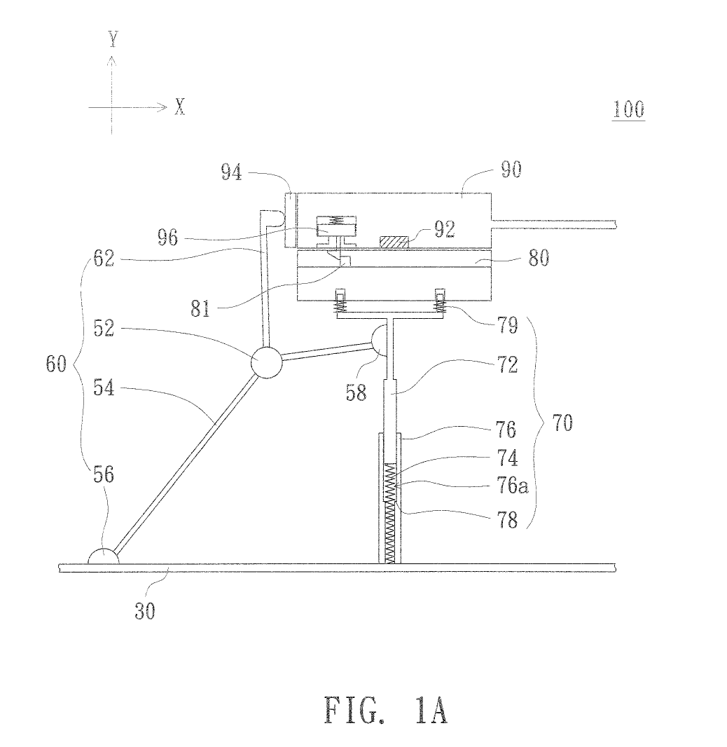

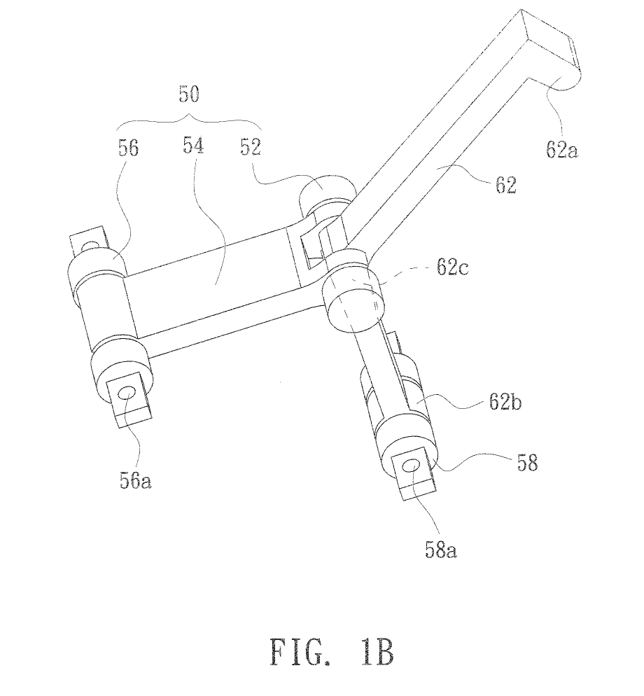

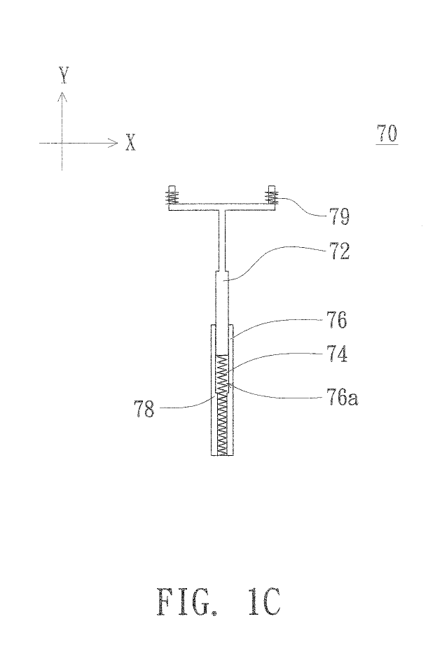

FIG. 1A illustrates an inkjet printing apparatus and a protecting structure of a cartridge thereof according to a first embodiment of the invention when the cartridge is at an initial position. For clarity, some components of the inkjet printing apparatus are not shown in FIG. 1A. Only related components are shown. Please referring to FIG. 1A, the printing apparatus 100 of the present embodiment includes a cartridge 90, a cap 80, a driving assembly 70 and a transmitting assembly 60. The cartridge 90 is movable along a first direction (i.e. +X axis direction). The cap 80 covers the cartridge 90 tightly for protecting the cartridge 90. The driving assembly 70 is connected to the cap 80 for providing a force to keep the cap 80 away from the cartridge 90 along a second direction (i.e. −Y axis direction). The transmitting assembly 60 is used for connecting the driving assembly 70 and the cartridge 90.

The cartridge 90 includes a nozzle surface 92. The cartridge 90 is movable back and forth along the first direction (i.e. +X axis direction). The nozzle surface 92 is used for jetting out ink on printing paper to print data. When the inkjet printing apparatus 100 is not in the process of printing, the cartridge 90 is at an initial position. At this time, the cap 80 covers the cartridge 90 for protecting the cartridge 90. Moreover, the cartridge 90 further includes a spacer 94. When the driving assembly 60 is against the cartridge 90, the spacer 94 is used for protecting the cartridge 90.

FIG. 1B illustrates the transmitting assembly in FIG. 1A. Please referring to both FIG. 1A and FIG. 1B, the transmitting assembly 60 preferably includes a crank lever 62 and a bearing assembly 50. The crank lever 62 has a first end 62a, a second end 62b and a curved portion 62c. The first end 62a is against the cartridge (such as the cartridge 90 in FIG. 1A). The second end 62b is pivoted to the driving assembly (such as the driving assembly 70 in FIG. 1A). The bearing assembly 50 is disposed on a housing (such as the housing 30 in FIG. 1A) of the inkjet printing apparatus and is pivoted to the curved portion 62c for bearing the crank lever 62. Additionally, the bearing assembly 50 includes a fixed hinge 56, a movable hinge 52 and a lever 54. The fixed hinge 56 is disposed on the housing 30. For example, the fixed hinge 56 is fixed on the housing 30 through a screw inserted in a hole 56a. The movable hinge 52 is pivoted to the curved portion 62c. Two ends of the lever 54 are pivoted to the movable hinge 52 and the fixed hinge 56. As a result, the crank lever 62 is movable relatively to the bearing assembly 50.

FIG. 1C illustrated the driving assembly in FIG. 1A. Please referring to bot FIG. 1A and FIG. 1C, the driving assembly 70 includes a supporting unit 72, an elastic unit 74 and a trough 76. The supporting unit 72 is connected to the cap 80. The elastic unit 74 is connected to the supporting unit 72 for providing the force. The elastic unit 74 is preferably a spring.

The driving assembly 70 further includes the trough 76. A chamber 76a is formed in the trough 76. The trough 76 is disposed around the supporting unit 72, and the elastic unit 74 is disposed in the trough 76 for connecting the trough 76 and the supporting unit 72. Accordingly, the elastic unit 74 provides the force when the external force is applied on the elastic unit 74. As a result, the supporting unit 72 moves along the chamber 76a, i.e. the Y-axis in FIG. 1C. Moreover, the trough further includes a bump 78 protruding in the chamber 76a. The bump 78 is used for blocking the supporting unit 72 when the supporting unit 72 moves along the chamber 76a under the elastic force. Additionally, the driving assembly further includes at least another elastic unit 79 disposed around the supporting unit 72. The elastic unit 79 is used for providing a force, so that the cap 80 covers the cartridge 90 tightly.

The inkjet printing apparatus 100 further includes another fixed hinge 58 disposed on the supporting unit 72. As shown in FIGS. 1A-1B, the fixed hinge 58 is used for connecting the second end 62b of the crank lever 62. For example, the fixed hinge 58 is fixed on the supporting unit through a screw inserted in a hole 58a.

Please referring to FIG. 1A, the cartridge 90 further includes an expandable restricting structure 96 against a protruding part 81 of the cap 80. When the cartridge 90 is at the initial position, the surface where the restricting structure 96 contacts the protruding part 81 is inclined greatly. As a result, the cartridge 90 can not move due to the insufficient force provided by the crank lever 62. The restricting structure 96 can not pass through the protruding part 81. Therefore, the cartridge 90 remains at the initial position stably. Meanwhile, the cartridge 90 is against the transmitting assembly 60 tightly to provide an external force. The transmitting assembly 60 transmits the external force to the driving assembly 70 to oppose the force. As a result, the cap 80 covers the cartridge 90. At the same time, the elastic unit 79 is used for providing an upward force, so that the cap 80 covers the cartridge 90 tightly.

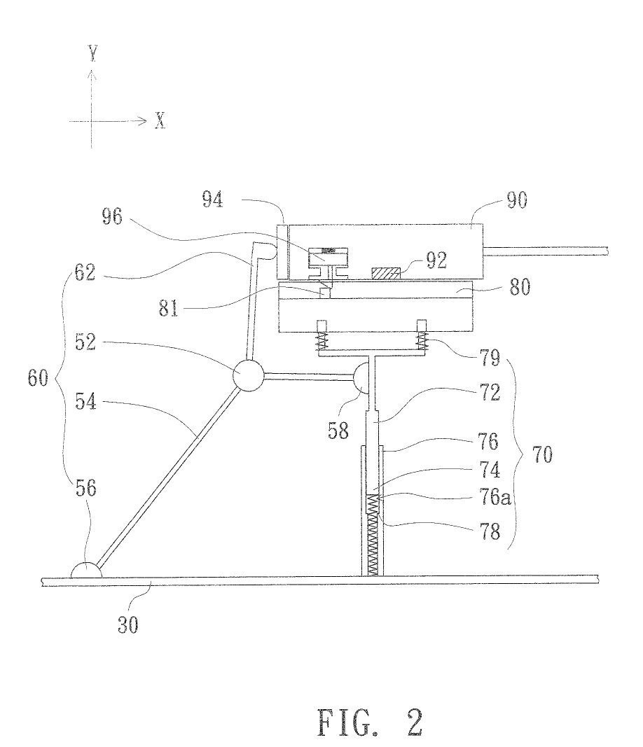

FIG. 2 illustrates the inkjet printing apparatus and the protecting structure of the cartridge thereof in FIG. 1A when the cartridge is away from the initial position. Please referring to FIG. 2, a motor provides a relatively strong force to drive the cartridge 90, so that the restricting structure 96 passes through the protruding part 81. In this process, the restricting structure 96 is pressed. When the cartridge 90 moves away from the initial position along the first direction (i.e. +X axis direction), the cartridge 90 does not contact the crank lever 62 tightly. Therefore, the crank lever 62 does not oppose a downward force generated by the elastic unit 74. As a result, the driving assembly 70 provides the force to keep the cap 80 away from the cartridge 90 along the second direction (i.e. −Y axis direction). The first direction is preferably perpendicular to the second direction substantially. In the inkjet printing apparatus and the protecting structure of the cartridge of the present embodiment, the protecting structure covers the cartridge selectively through some assemblies in coordination with the reciprocation of the cartridge. The protecting structure moves corresponding to the reciprocating movement of the cartridge. No extra power is needed to drive the protecting structure.

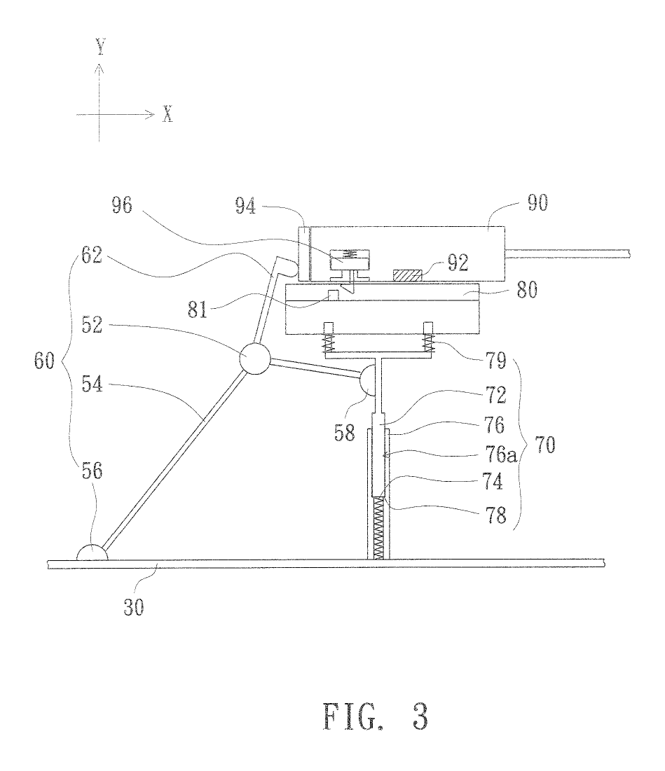

When the cartridge 90 continuously moves along the first direction (i.e. +X axis direction), the cap 80 keeps moving along the second direction (i.e. −Y axis direction) to a final position. FIG. 3 illustrates the inkjet printing apparatus and the protecting structure of the cartridge thereof in FIG. 1A when the cartridge is away from the transmitting assembly. The cartridge 90 moves away from the transmitting assembly 60 to print data. Meanwhile, the elastic unit 74 keeps the supporting unit 72 downwards, so that the supporting unit 72 is tightly against the bump 78. The bump 78 is used for restricting the supporting unit 72 from moving further. As a result, the cap 80 is positioned without moving further.

When the cartridge 90 finishes printing and starts to move back to the initial position, the restricting structure 96 contacts the protruding part 81. The restricting structure 96 is pressed and moves upwards along the inclined surface, as shown in FIG. 2. Because the surface where the restricting structure 96 contacts the protruding part 81 is less inclined, the motor provides relatively weaker power to drive the restricting structure 96 to pass through the protruding part 81. When the cartridge 90 moves back to the initial position, the cartridge 90 is tightly against the transmitting assembly 60 again. As a result, the cap 80 covers the cartridge 90, and the cartridge 90 is not exposed to the air, as shown in FIG. 1A. Therefore, ink does not remain in the nozzle surface, so that the nozzle surface is not clogged. Furthermore, the nozzle surface is isolated from the particles in the air, and the printing quality is increased greatly.

### Second Embodiment

The design of the driving assembly and the position of the fixed hinge in the present embodiment are different from those in the above embodiment. Other components are the same and use the same reference numbers without repeated description.

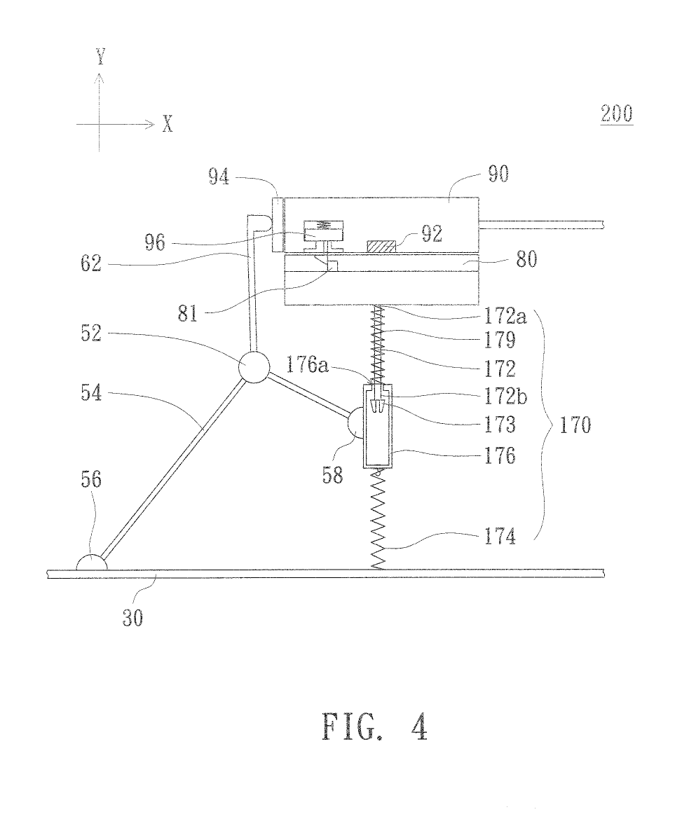

FIG. 4 illustrates an inkjet printing apparatus and a protecting structure of a cartridge thereof according to a second embodiment of the invention when the cartridge is at an initial position. Please referring to FIG. 4, an inkjet printing apparatus 200 of the present embodiment includes a cartridge 90, a cap 80, a driving assembly 170 and a transmitting assembly 60.

The driving assembly 170 includes a supporting unit 172, a trough 176 and an elastic unit 174. The supporting unit 172 has a first end 172a and a second end 172b. The first end 172a is connected to the cap 80, and the second end 172b includes a bump 173. The trough 176 has an opening 176, and the bump 173 is stuck in the trough 176 through the opening 176a. The trough 176 is disposed around the second end 172b of the supporting unit 172, so that the supporting unit 172 is movable along the trough 176. The area of the opening 176a is less than a cross-sectional area of the second end 172b of the supporting unit 172. The elastic unit 174 is disposed in a housing 300 of the inkjet printing apparatus 200 to provide a force. Moreover, the driving assembly 170 further includes at least another elastic unit 179 disposed around the supporting unit 172 to provide a force.

The inkjet printing apparatus 200 further includes a fixed hinge 158 disposed on the trough 176 to connect a crank lever 62 of the transmitting assembly 60.

Please referring to FIG. 4, when the cartridge 90 is at an initial position, the cartridge 90 is tightly against the crank lever 62 to oppose the force provided by the elastic unit 174. As a result, the cap 80 covers the cartridge 90. Meanwhile, the elastic unit 179 provides a force, so that the cap 80 covers the cartridge 90 tightly.

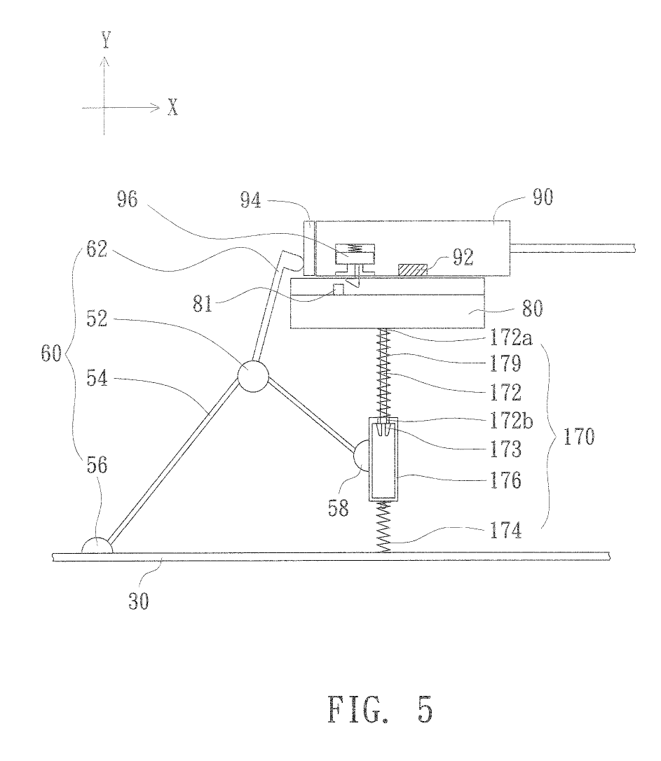

FIG. 5 illustrates the inkjet printing apparatus and the protecting structure of the cartridge thereof in FIG. 4 when the cartridge is away from the initial position. Please referring to FIG. 5, when the cartridge 90 moves away from the initial position along a first direction (i.e. +X axis direction), the elastic unit 174 keeps the trough 176. As a result, the bump 113 is stuck in the trough 176 through the opening 176a, and the supporting unit 172 moves accordingly. Therefore, the cap 80 moves along a second direction (i.e. −Y axis direction) away from the cartridge 90.

In the inkjet printing apparatus and the protecting structure of the cartridge thereof according to the above embodiments, the protecting structure moves correspondingly to the reciprocating movement of the cartridge. As a result, the protecting structure covers the cartridge selectively. When the cartridge is not in the process of printing, the protecting structure covers the cartridge tightly. Therefore, the cartridge is not exposed to the air. Ink does not remain on the nozzle surface, so that the nozzle is not clogged. Also, the nozzle surface is isolated from the particles in the air, so that the printing quality is increased greatly. Furthermore, the protecting structure moves correspondingly to the motion of the cartridge. There is no extra energy required to drive the protecting structure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An inkjet printing apparatus comprising:
a cartridge movable along a first direction;
a cap used for protecting the cartridge;
a driving assembly connected to the cap for providing a force to keep the cap away from the cartridge along a second direction, and
a transmitting assembly used for connecting the driving assembly and the cartridge;
wherein the cartridge is against the transmitting assembly to provide an external force when the cartridge is at an initial position, and the transmitting assembly transmits the external force to the driving assembly to oppose the force so that the cap covers the cartridge tightly;
wherein the driving assembly provides the force when the car ridge moves away from the initial position along the first direction so that the cap moves away from the cartridge along the second direction.

2. The inkjet printing apparatus according to claim 1, wherein the transmitting assembly comprises:
a crank lever comprising a first end, a second end and a curved portion, the first end being against the cartridge, the second end being pivoted to the driving assembly; and
a bearing assembly comprising:
a fixed hinge disposed on a housing;
a movable hinge pivoted to the curved portion; and
a lever with two ends pivoted to the movable hinge and the fixed hinge respectively;
wherein the bearing assembly is used for bearing the crank lever so that the crank lever is movable relatively to the bearing assembly.

3. The inkjet printing apparatus according to claim 2, wherein the driving assembly comprises:
a supporting unit connected to the cap; and
a trough with a chamber, wherein the trough is disposed around the supporting unit and supporting unit is movable along the trough.

4. The inkjet printing apparatus according to claim 3, wherein the trough further comprises:
an elastic unit connected to the supporting unit, wherein the supporting unit moves along the chamber when the force is applied to the elastic unit.

5. The inkjet printing apparatus according to claim 3, wherein the trough further comprises a bump disposed in the chamber, the bump being used for blocking the supporting unit when the supporting unit moves along the chamber under the elastic force.

6. The inkjet printing apparatus according to claim 3, wherein the driving assembly further comprises at least another elastic unit disposed around the supporting unit for providing a force to tightly connect the cap and the cartridge.

7. The inkjet printing apparatus according to claim 3 further comprising another fixed hinge, connecting the supporting unit and the second end.

8. The inkjet printing apparatus according to claim 2, wherein the driving assembly comprises:
a supporting unit comprising a first end and a second end, the first end connecting to the cap, the second end comprising a bump; and
a trough with an opening, the trough disposed around the second end of the supporting unit, the bump stuck in the trough through the opening;
wherein the supporting unit is movable along the trough.

9. The inkjet printing apparatus according to claim 8, wherein the driving assembly further comprises:
an elastic unit disposed in the housing and connected to the trough for providing the force, wherein the supporting unit moves accordingly when the elastic unit keeps the trough, so that the cap moves along the second direction.

10. The inkjet printing apparatus according to claim 8, wherein the driving assembly further comprises at least another elastic unit disposed around the supporting unit for providing a force to tightly connect the cap and the cartridge.

11. A protecting structure disposed in an inkjet printing apparatus, the inkjet printing apparatus comprising at least a housing and a cartridge, the cartridge movable along a first direction, the protecting structure comprising:
a cap relative to the cartridge;
a driving assembly connected to the cap for providing a force so that the cap moving away from the cartridge along a second direction; and
a transmitting assembly used for connecting the driving assembly and the cartridge;
wherein the cartridge is against the transmitting assembly to provide an external force when the cartridge is at an initial position, the transmitting assembly transmitting the external force to the driving assembly to oppose the force, so that the cap covering the cartridge;
wherein the driving assembly provides the force when the cartridge moves away from the initial position along the first direction so that the cap moves away from the cartridge along the second direction.

12. The protecting structure according to claim 11, wherein the transmitting assembly comprises:
a crank lever comprising a first end, a second end and a curved portion, the first end being against the cartridge, the second end being pivoted to the driving assembly; and
a bearing assembly comprising:
a fixed hinge disposed on the housing;
a movable hinge pivoted to the curved portion; and
a lever with two ends pivoted to the movable hinge and the fixed hinge respectively;
wherein the bearing assembly is used for bearing the crank lever, so that the crank lever is movable relatively to the bearing assembly.

13. The protecting structure according to claim 12, wherein the driving assembly further comprises:
a supporting unit connected to the cap; and
a trough with a chamber, the trough disposed around the supporting unit;
wherein the supporting unit is movable along the trough.

14. The protecting structure according to claim 13, wherein the trough further comprises:
an elastic unit connected to the supporting unit for connecting the supporting unit and the trough, wherein the supporting unit moves along the chamber when the external force is applied to the elastic unit.

15. The protecting structure according to claim 13, wherein the trough further comprises a bump protruding in the chamber,
wherein the bump is used for blocking the supporting unit when the supporting unit moves along the chamber under the elastic force.

16. The protecting structure according to claim 13, wherein the driving assembly further comprises at least another elastic unit disposed around the supporting unit for providing a force to tightly connect the cap and the cartridge.

17. The protecting structure according to claim 13 further comprising another fixed hinge disposed on the supporting unit for connecting the second end.

18. The protecting structure according to claim 12, wherein the driving assembly comprises:
a supporting unit comprising a first end and a second end, the first end connected to the cap, the second end comprising a bump; and
a trough with an opening, the trough disposed around the second end of the supporting unit, the bump stuck in the trough through the opening;
wherein the supporting unit is movable along the trough.

19. The protecting structure according to claim 18, wherein the driving assembly further comprises:
an elastic unit disposed in the housing and connected to the trough for providing the force, wherein the supporting unit moves accordingly when the trough is kept by the elastic unit, so that the cap moves along the second direction.

20. The protecting structure according to claim 18, wherein the driving assembly further comprises at least another elastic unit disposed around the supporting unit for providing a force to tightly connect the cap and the cartridge.

21. The protecting structure according to claim 18 further comprising another fixed hinge disposed on the trough for connecting the second end.
